(19) United States
(12) Patent Application Publication
(10) Pub. No.: US 2016/0338533 A1
(43) Pub. Date: Nov. 24, 2016

(54) GLOWING SKEWER

(71) Applicant: Eric J. Wangler, Rochester, NY (US)

(72) Inventor: Eric J. Wangler, Rochester, NY (US)

(21) Appl. No.: 14/716,085

(22) Filed: May 19, 2015

(51) Int. Cl. A47J 37/04

(52) U.S. Cl. CPC A47J 37/04

(57) ABSTRACT

A skewer with a glow-in-the-dark handle for holding food over a flame includes an elongate wooden body with a sharpened first end and a second end covered by a sleeve or cap formed of a phosphorescent material.

### BACKGROUND OF THE INVENTION

The present invention is generally directed to cooking apparatus and, more particularly, to glow-in-the dark apparatus for holding a food item during cooking, especially when grilling or toasting the food over a flame.

Grilling food over an open flame is a popular activity, especially during the warmer months of the year. When food is cooked over a flame, the food must be supported with an apparatus or tool, so that the user does not get burned. For example, charcoal grills usually include a grate that supports the food, such as steak or hamburgers, over the burning coals. A grill basket may be placed on the grate to support vegetables over the coals. In another example, marshmallows and hotdogs are often cooked over an open wood fire by skewering them with a long stick and then holding them over the fire. Many metal skewers, toasting forks, hinged hamburger holders and grill baskets are known in the art, as are bamboo skewers and sticks collected from shrubs in the area surrounding the fire.

Night time campfire activities, including grilling, are popular with groups, such as scouting groups, youth groups, and the like. If a skewer used for such grilling is dropped, it may be difficult to find in the dark and may be damaged or cause injury by bodily contact with the point of an unseen skewer.

### SUMMARY OF THE INVENTION

The present invention provides a skewer with a glowing handle portion, for use when holding food over an open wood or charcoal fire for cooking.

The present invention is directed to embodiments of a skewer for holding a food item and comprising: an elongated body with opposite ends and a cover ensleeved over an end of the body, the cover including a material having enhanced visibility in darkness. The sleeve may be closed at one end to form a cap which is received over an end of the skewer. The skewer typically has one end which is pointed or sharpened to enable the skewer to pierce a food item. The sleeve may be dimensioned so that it can be received over the pointed end of the skewer to prevent undesired contact therewith or, alternatively, over an unpointed end of the skewer during use while grilling, roasting, toasting, or generally cooking a food item over a campfire. The material having enhanced visibility in darkness may be a phosphorescent material capable of glowing in the dark.

The skewer is a thin, elongate rod or shaft with a sharp, pointed first end and an unpointed second end that is covered by the high visibility sleeve. The skewer rod is long and thin with a sharpened first end that is used to pierce the food. Once the food is pierced, it is pushed onto the rod, so that it will be supported by the rod body. The rod is sufficiently long and rigid that a person using the skewer can hold the food over the fire without a significant risk of being burned. The skewer sleeve may function as a grip for holding the rod and an optional cover for the pointed first end. For children, the high visibility, or glow-in-the-dark, sleeve makes the cooking activity more fun. For adults, the skewer provides convenience, since the skewers are pre-made and can be purchased and stored for later use. Further, the skewer improves safety by increasing illumination at night and by eliminating concerns associated with accidentally using a toxic stick found outdoors, such as an oleander branch, as a grilling or toasting skewer. Additionally, the high visibility, particularly phosphorescent, sleeve makes a dropped skewer easier to find in the dark.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a perspective view of an embodiment of a skewer according to the present invention, and including a food item, such as a marshmallow.

FIG. 2 is an enlarged fragmentary, exploded side view of the skewer of FIG. 1, with a high visibility sleeve shown separated therefrom.

FIG. 3 is an enlarged fragmentary cross-sectional view of the skewer of FIG. 2, taken along the line 3-3 of FIGS. 2, and showing the high visibility sleeve positioned on an end of the skewer.

FIG. 4 is a view similar to FIG. 3 and shows the sleeve positioned on a pointed end of the skewer.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

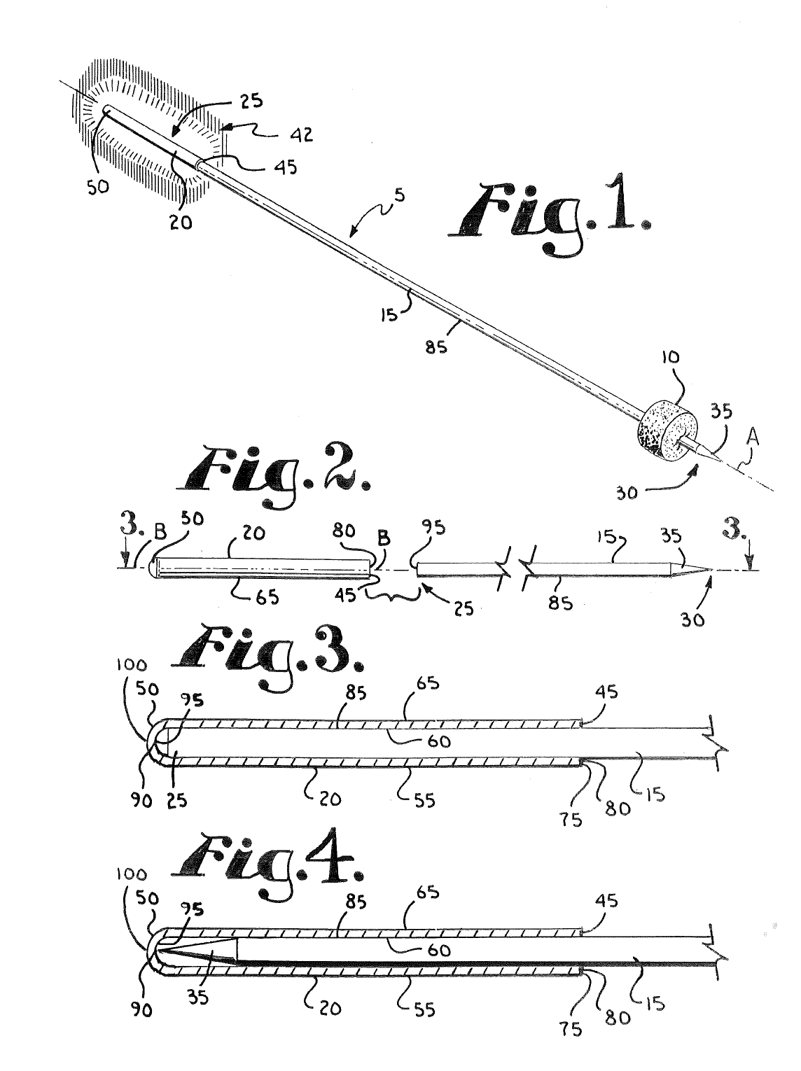

Referring now to FIGS. 1-3, the reference numeral 5 generally represents a glowing skewer apparatus or assembly for holding a food item 10 over an open flame (not shown), such as a charcoal grill or a camp fire. Foods 10 for use with the skewer 5 may include marshmallows 10, meats (not shown), breads (not shown), fruits (not shown), and/or vegetables (not shown). For example, at campfire cook-outs, it is often popular to toast marshmallows 10 for making confections known as “s′mores” by holding the marshmallows 10 over a camp fire (not shown).

The illustrated skewer assembly 5 includes a skewer body 15 and a high visibility cover or cap 20 ensleeved over a portion of the skewer body 15. The body 15 is a rod or shaft which is sized and shaped to receive the food 10 thereon, so as to enable a user to support the food 10 away from his body. Accordingly, the skewer body 15 is an elongated rod, which may have a length of at least three feet (or about one meter). The illustrated skewer body 15 has a longitudinal axis A that extends from a first or unpointed end 25 to a second or pointed end 30. A cross-section of the skewer body 15, perpendicular to the longitudinal axis A, may be circular, oval, or rectangular and is typically circular. The skewer body 15 may be formed of wood, metal, a polymer, or a combination thereof, as is known in the art. For example, the body 15 may be formed of a long, thin wooden dowel. Preferred woods may include bamboo, birch, white birch, maple, oak, or the like.

The unpointed first end 25 of the skewer body 15 is illustrated as blunt or rounded (see FIG. 3), while the pointed second end 30 includes a tapered portion 35 for piercing the food 10 (FIGS. 1-3). During use, the user penetrates the tapered portion 35 through the food item 10 and then pushes the food item 10 onto the body 15. In some embodiments, both the first and second ends 25, 30 may be tapered portion (not shown). For example, the user may use the pointed end 30 for toasting marshmallows 10 until it is damaged by heat from the campfire, and then turn the body 15 around and use the a pointed first end 25 for toasting more marshmallows 10.

The illustrated cover or cap 20 is a sleeve-like tubular member or tube 40 formed of a material which is light emitting or which has enhanced visibility in darkness. The enhanced visibility material may be highly reflective or may b retroreflective, that is, strongly reflective toward a light source which illuminates it. Additional information about retroreflective materials can be found in U. S. Pat. Nos. 2,326,634 and 5,738,746, which are incorporated herein by reference. Alternatively, the enhanced visibility material may be phosphorescent which, when exposed to light, slowly re-emits the light. The cover 20 formed of such a material produces a glow when in darkened conditions, as is diagrammatically indicated in FIG. 1 at 42. In some circumstances, the cover 20 may be fabricated of metal or a polymer and then painted with a phosphorescent paint, such as is known in the art.

The illustrated cover 20 includes a longitudinal axis B (FIG. 2), an open end 45 and an opposite closed end 50. An elongate side wall 55 with inner and outer surfaces 60, 65, respectively, joins the open and closed ends 45, 50. The wall inner surface 60 is curvate and defines a central through channel 70. For example, the inner surface 60 may be cylindrical in shape. The channel 70 is sized and shaped to receive the body first end 25 therein, whereby the cover 20 can be used as a grip or handle-like structure. Accordingly, the channel 70 is complementary in size and shape to at least the body first end 25. When received onto the rod first end 25, the cover 20 and the rod 15 are coaxial with each other. It is foreseen that both ends of the cover 20 may open, so that the cover 20 can be placed over a portion of the body 15 between the first and second ends 25, 30.

At the open end 45, the wall 55 includes an edge 75 that joins the wall inner and outer surfaces 60, 65 (see FIG. 3), and thereby defines an opening or orifice 80. The opening 80 is sized and shaped to receive the body 15 therein. In some embodiments, the inner surface 60 slidingly engages an outer surface 85 of the body 15. It is foreseen that the wall inner surface 60 may be slightly spaced from the body outer surface 85. In such circumstances, an adhesive (not shown), such as those known in the art, may be used to attach the cover 20 to the body 15.

The closed end 50 of the cover wall 55 includes a stop portion 90 with a stop inner surface 95 and a stop outer surface 100. As shown in FIG. 3, the wall inner surface 60 is joined with the stop inner surface 95 and the wall outer surface 65 is joined with the stop outer surface 100. When in use, the stop inner surface 95 engages the body first end 25. In some embodiments, the first end 25 is complementary in shape to the stop inner surface 95 so as to be matingly engageable. In some embodiments, the cover 20 can be removed from the first end 25 and placed over the pointed end 30, so as to prevent the tapered portion 35 from piercing or otherwise injuring someone. Placement of the cover 20 over the pointed end 30 may be advantageous for safe packaging of the skewer 5 for sale. It is foreseen that the body first and second ends 25, 30 may each include a tapered portion 35, each of which includes a cover 20 that protects the associated sharp tapered portion 35. When both of the rod first and second ends 25, 30 include a tapered portion 35 or point, the cover is movable and can be used to cover either of the first and second ends 25, 30 while the opposite end is being used to cook food 10.

It is to be understood that while certain forms of the present invention have been illustrated and described herein, it is not to be limited to the specific forms or arrangement of parts described and shown.

What is claimed and desired to be secured by Letters Patent is as follows:

1. A skewer for holding a food item and comprising:
a) an elongated body with opposite ends; and
b) a cover ensleeved over a portion of the body, the cover including a material having enhanced visibility in darkness.

2. The skewer according to claim 1, wherein:
a) an end of the body is tapered.

3. The skewer according to claim 1, wherein:
a) an end of the body is sized and shaped to pierce a food item.

4. The skewer according to claim 3, wherein:
a) the body is sized and shaped to receive the food item thereon; and
b) the body supports the food item.

5. The skewer according to claim 1, wherein the body includes:
a) a horizontal cross-section that is one of circular, oval, and rectangular.

6. The skewer according to claim 1, wherein:
a) the body is formed of a material which includes at least one of wood, metal, and a polymer.

7. The skewer according to claim 1, wherein the cover includes an elongated wall having:
a) an inner surface and an outer surface; and
b) an open end and an opposite closed end.

8. The skewer according to claim 7, wherein the wall includes:
a) an edge at the open end; and
b) the edge defining an orifice sized and shaped to receive the body first end therethrough.

9. The skewer according to claim 7, wherein the wall includes:
a) a stop portion at the closed end, the stop portion having inner and outer surfaces.

10. The skewer according to claim 7, wherein:
a) the wall inner surface defines a through channel sized and shaped to receive an end of the body therein.

11. The skewer according to claim 1, wherein:
a) the material having enhanced visibility in darkness is a phosphorescent polymer.

12. The skewer according to claim 1, further comprising:
a) a glue adhering the sleeve to an end of the body.

13. The skewer according to claim 1 wherein:
a) an end of the body is a pointed end shaped to pierce a food item; and
b) the cover is sized and shaped to be received over the pointed end to prevent contact therewith and alternatively over the opposite end to enhance visibility of the skewer in darkness.

14. A skewer for holding a food item and comprising:
a) an elongated body with opposite ends;
b) an end of the body being a pointed end shaped to pierce a food item;
c) a cover ensleeved over an end of the body, the cover including a material having enhanced visibility in darkness; and
d) the cover is sized and shaped to be received over the pointed end to prevent contact therewith and alternatively over the opposite end to enhance visibility of the skewer in darkness.

15. A skewer as set forth in claim 14 wherein:
a) the material having enhanced visibility is a phosphorescent material.

16. A skewer as set forth in claim 14 wherein:
a) the material having enhanced visibility is a phosphorescent polymer.

17. A skewer cover for use with a skewer and comprising:
a) a substantially tubular sleeve;
b) the sleeve including a material having enhanced visibility in darkness; and
c) the sleeve being dimensioned to enable it to be ensleeved over a skewer.

18. A cover as set forth in claim 17 wherein:
a) the sleeve is closed at one end.

19. A cover as set forth in claim 17 wherein:
a) the material having enhanced visibility in darkness is a phosphorescent material.

20. A cover as set forth in claim 17 wherein:
a) the material having enhanced visibility in darkness is a phosphorescent polymer.
